(19) United States
(12) Patent Application Publication
(10) Pub. No.: US 2024/0207791 A1
(43) Pub. Date: Jun. 27, 2024

(54) METAL ORGANIC FRAMEWORK POLYTETRAFLUOROETHYLENE COMPOSITE STRUCTURE AND METHOD OF MAKING THE SAME

(71) Applicant: W. L. Gore & Associates, Inc., Newark, DE (US)

(72) Inventors: Zhuonan Song, Elkton, MD (US); Stephen K. Stark, Wilmington, DE (US); Jeffrey Knopf, Wilmington, DE (US); Guo Shiou Foo, Newark, DE (US)

(21) Appl. No.: 18/287,907

(22) PCT Filed: Apr. 4, 2022
(86) PCT No.: PCT/IB2022/053117

§ 371 Date: Oct. 23, 2023

Related U.S. Application Data
(60) Provisional application No. 63/178,899, filed on Apr. 23, 2021.

(51) Int. Cl. B01D 67/00; B01D 69/12; B01D 71/02; C07F 3/06; C07F 5/06

(52) U.S. Cl. CPC B01D 67/0079; B01D 69/12; B01D 71/028; C07F 3/06; C07F 5/069

(57) ABSTRACT

A method of producing a structured MOF composite tape by immobilizing metal chalcogenide particles into a polymer matrix, and then converting the metal chalcogenide into MOF in-situ. In some embodiments, the conversion is from ZnO-PTFE composite to ZIF-8-PTFE composite. ZIF-8-PTFE composite is a useful material for propylene/propane separation, oil capture, and photocatalytic killing against airborne bacteria. Besides ZIF-8, a structured MOF composite tape is a useful material for chemical separation including but not limited to chemical purification, air purification, and removal of biological toxicants. Additionally, a composite article which includes the MOFs may be in the form of a filter bag, a honeycomb, a column, or other suitable forms.

### CROSS-REFERENCE TO RELATED APPLICATION

This application is a national phase application of PCT Application No. PCT/IB2022/053117, internationally filed on Apr. 4, 2022, which claims the benefit of U.S. Provisional Application 63/178,899, filed Apr. 23, 2021, which are herein incorporated by reference in their entireties for all purposes.

### FIELD OF THE TECHNOLOGY

This disclosure relates generally to chemical separation materials, and more specifically, to a porous fibrillated polymer membrane that includes supported particles placed within the porous fibrillated polymer membrane that may be used to separate chemicals.

### BACKGROUND

Composite filters can have a porous material disposed within a matrix. As fluid passes over or through the matrix, certain components within the fluid can be separated from others. Hybrid porous materials, such as metal organic frameworks (MOFs), combine metal atoms with bridging organic ligands. However, the high cost of manufacture of MOFs has limited large-scale applications of MOFs. Besides the high cost, the poor processability and handling of MOFs powders also hamper their wide use in various applications.

### SUMMARY

There is a need for novel and improved materials disposed on a polymer matrix, such as a porous MOF composite structure. There is also a need of novel and improved processes for producing MOFs. This disclosure is directed towards such compositions and methods of producing thereof.

Any or all portion(s) of any of the embodiments disclosed herein may be combined with any other portion(s) of any embodiment.

In some embodiments, a method comprises converting a porous metal salt polymer composite structure to a porous metal-organic framework (MOF) composite structure. For example, according to some embodiments, the method comprises converting, in-situ, a porous metal salt polymer composite structure to a porous metal-organic framework (MOF) composite structure. In some embodiments of the method, the porous metal salt polymer composite structure comprises a metal chalcogenide polymer composite structure.

In some embodiments of the method, the porous metal chalcogenide polymer composite structure comprises a metal oxide. In some embodiments of the method, the metal oxide is selected from the group consisting of transition metal oxide, Group 4 metal oxide, Group 5 metal oxide, Group 6 metal oxide, Group 7 metal oxide, Group 8 metal oxide, Group 9 metal oxide, Group 10 metal oxide, Group 11 metal oxide, Group 12 metal oxide, Group 13 metal oxide, and a combination thereof. In some embodiments of the method, the metal oxide is selected from the group consisting of V₂O₅, Fe₂O₃, CuO, ZnO, Al₂O₃, ZrO₂, MgO, MnO, CoO, NiO, and a combination thereof.

In some embodiments of the method, the porous metal chalcogenide polymer composite structure comprises a metal chalcogenide. In some embodiments of the method, the metal chalcogenide comprises at least one metal atom, wherein the at least one metal atom is selected from the group consisting of a transition metal, Group 3 metal, Group 4 metal, Group 5 metal, Group 6 metal, Group 7 metal, Group 8 metal, Group 9 metal, Group 10 metal, Group 11 metal, Group 12 metal, and a combination thereof. In some embodiments of the method, the metal chalcogenide comprises a chalcogen atom selected from the group consisting of S, Se, and Te. In some embodiments of the method, the metal chalcogenide is ZrS₂, ZnS, or a combination thereof.

In some embodiments of the method, the porous metal salt polymer composite structure comprises a metal oxalate. In some embodiments of the method, the metal oxalate is selected from the group consisting of iron oxalate, copper oxalate, zirconium oxalate, aluminum oxalate, magnesium oxalate, nickel oxalate, cobalt oxalate, cerium oxalate, manganese oxalate, chromium oxalate, including but not limited to zinc oxalate.

In some embodiments of the method, the porous metal salt polymer composite structure comprises a metal carbonate. In some embodiments of the method, the metal carbonate is selected from the group consisting of iron carbonate, copper carbonate, zirconium carbonate, aluminum carbonate, magnesium carbonate, nickel carbonate, cobalt carbonate, cerium carbonate, manganese carbonate, chromium carbonate, including but not limited to zinc carbonate.

In some embodiments, the method comprises producing a structural configuration of the porous metal salt polymer composite structure. In some embodiments of the method, the structural configuration comprises a film, a laminate, a tube, a wound roll, a tape, a pellet, a column, a monolith, a module, a honeycomb-shape, or a combination thereof.

In some embodiments of the method, the converting the porous metal chalcogenide polymer composite structure to a porous MOF composite structure comprises a vapor treatment process. In some embodiments of the method, the converting the porous metal chalcogenide polymer composite structure to a porous MOF composite structure comprises a liquid treatment process.

In some embodiments of the method, the porous metal chalcogenide polymer composite structure comprises Polytetrafluoroethylene (PTFE).

In some embodiments of the method, the porous metal chalcogenide polymer composite structure comprises poly(ethylene-co-tetrafluoroethylene) (ETFE), ultra-high molecular weight polyethylene (UHMWPE), polyparaxylylene (PPX), polylactic acid and any combination or blend thereof.

In some embodiments of the method, the porous MOF composite structure comprises PTFE.

In some embodiments of the method, the porous MOF composite structure comprises at least a MOF or a mixture of MOFs selected from the group consisting of ZIF-7, ZIF-8, ZIF-9, ZIF-10, ZIF-12, ZIF-67, ZIF-68, ZIF-69, ZIF-70, ZIF-78, ZIF-79, ZIF-81, ZIF-82, ZIF-90, ZIF-8-90, ZIF-L, CALF-15, CALF-20, MOF-2, MOF-3, MOF-4, MOF-5, MOF-70, MOF-73, MOF-74, MOF-75, MOF-76, MOF-177, COF-1, COF-5, COF-8, COF-105, COF-108, MIL-101, MIL-53, MIL-53-NH2, MIL-96, CAU-10, CAU-10-H, MOF-303, MOF-505, MOF-801, MOF-808, Al(OH)fumarate, Mg-formate, Zr-Fumarate, UiO-66, UiO-66-NH2, UiO-67, UiO-68, HKUST-1, Fe-BTC, PCN-224, PCN-250, and UTSA-16.

In some embodiments of the method, porosity of porous metal chalcogenide polymer composite includes a range of about 10% to about 95%. In some embodiments of the method, at least 5% of porosity comprises a pore size greater than 0.1 μm.

In some embodiments of the method, the porous metal salt polymer composite structure comprises a porous ZnO PTFE composite structure.

In some embodiments of the method, the porous MOF composite structure comprises ZIF-8-PTFE.

In some embodiments of the method, the porous metal salt polymer composite structure comprises a porous metal oxide polymer composite film.

In some embodiments of the method, the porous MOF composite structure comprises a porous MOF composite film.

In some embodiments of the method, the porous metal salt polymer composite structure comprises a metal oxide polymer composite column.

In some embodiments of the method, the porous MOF composite structure comprises a porous MOF composite column.

In some embodiments, the method further comprises forming the porous metal salt polymer composite structure.

In some embodiments, a porous MOF composite structure comprises PTFE; and MOF durably enmeshed in the PTFE.

In some embodiments, a porous MOF composite structure comprises ePTFE; and MOF durably enmeshed in the ePTFE.

In some embodiments, the MOF is selected from the group consisting of ZIF-7, ZIF-8, ZIF-9, ZIF-10, ZIF-12, ZIF-67, ZIF-68, ZIF-69, ZIF-70, ZIF-78, ZIF-79, ZIF-81, ZIF-82, ZIF-90, ZIF-8-90, ZIF-L, CALF-15, CALF-20, MOF-2, MOF-3, MOF-4, MOF-5, MOF-70, MOF-73, MOF-74, MOF-75, MOF-76, MOF-177, COF-1, COF-5, COF-8, COF-105, COF-108, MIL-101, MIL-53, MIL-53-NH2, MIL-96, CAU-10, CAU-10-H, MOF-303, MOF-505, MOF-801, MOF-808, Al(OH)fumarate, Mg-formate, Zr-Fumarate, UiO-66, UIO-66-NH2, UiO-67, UIO-68, HKUST-1, Fe-BTC, PCN-224, PCN-250, and UTSA-16.

In some embodiments of the porous MOF composite structure, a metal of the MOF is selected from the group consisting of transition metal, Group 4 metal, Group 5 metal, Group 6 metal, Group 7 metal, Group 8 metal, Group 9 metal, Group 10 metal, Group 11 metal, Group 12 metal, Group 13 metal, V, Fe, Cu, Zn, Al, Zr, Mg, Mn, Co, and Ni.

In some embodiments of the porous MOF composite structure, the porosity of the porous MOF composite structure includes a range of about 10% to about 95%.

In some embodiments of the porous MOF composite structure, a Brunauer-Emmett-Teller (BET) surface area is in a range of 20 m²/g to 4000 m²/g.

In some embodiments of the porous MOF composite structure, the porous MOF composite structure comprises a porous MOF composite film.

In some embodiments of the porous MOF composite structure, the porous MOF composite film has a thickness of about 0.001 mm to 5 mm.

In some embodiments, the porous MOF composite film has a thickness of about 0.001 mm to 0.01 mm. In some embodiments, the porous MOF composite film has a thickness of about 0.01 mm to 1.5 mm. In some embodiments, the porous MOF composite film has a thickness of about 0.01 mm to 5 mm. In some embodiments, the porous MOF composite film has a thickness of about 1.5 mm to 5 mm.

In some embodiments of the porous MOF composite structure, the porous MOF composite film comprises a MOFs layer on at least one side of an external surface of the porous MOF composite film.

In some embodiments of the porous MOF composite structure, the MOFs layer on the external surface has a thickness of about 0.001 mm to about 5 mm.

In some embodiments of the porous MOF composite structure, the porous MOFs composite structure has a tensile strength greater than 1 pound per square inch.

In some embodiments, the method comprises producing a structural configuration of a porous metal salt polymer composite structure, and then converting the porous metal salt polymer composite structure to a porous metal-organic framework (MOF) composite structure.

In some embodiments, a composite article comprises a porous fibrillated polymer membrane that includes supported particles durably enmeshed within the porous fibrillated polymer membrane.

In some embodiments, the porous metal salt polymer composite structure is or includes a porous metal chalcogenide polymer composite structure.

In some embodiments, the porous MOF composite film comprises a MOFs layer on at least two sides of an external surface of the porous MOF composite film.

In some embodiments, the porous MOF composite film comprises a MOFs layer on two opposing sides of an external surface of the porous MOF composite film.

In some embodiments of the porous MOF composite structure, the MOFs layer on the external surface has a thickness of about 0.001 mm to about 5 mm. In some embodiments, the MOFs layer on the external surface has a thickness of about 0.001 mm to about 0.01 mm. In some embodiments, the MOFs layer on the external surface has a thickness of about 0.01 mm to about 1.5 mm. In some embodiments, the MOFs layer on the external surface has a thickness of about 0.01 mm to about 5 mm. In some embodiments, the MOFs layer on the external surface has a thickness of about 1.5 mm to about 5 mm.

In some embodiments, a method comprises converting a porous metal salt polymer composite structure to a porous metal-organic framework (MOF) composite structure. In some embodiments of the method, the porous metal salt polymer composite structure comprises a metal chalcogenide. In some embodiments, the porous metal chalcogenide polymer composite structure comprises a metal oxide. In some embodiments, the metal oxide is selected from the group consisting of transition metal oxide, Group 4 metal oxide, Group 5 metal oxide, Group 6 metal oxide, Group 7 metal oxide, Group 8 metal oxide, Group 9 metal oxide, Group 10 metal oxide, Group 11 metal oxide, Group 12 metal oxide, Group 13 metal oxide, and a combination thereof. In some embodiments, the metal oxide is selected from the group consisting of V₂O₅, Fe₂O₃, CuO, ZnO, Al₂O₃, ZrO₂, MgO, MnO, CoO, NiO, and a combination thereof. In some embodiments, the porous metal chalcogenide polymer composite structure comprises a metal chalcogenide. In some embodiments, the metal chalcogenide comprises at least one metal atom, wherein the at least one metal atom is selected from the group consisting of a transition metal, Group 3 metal, Group 4 metal, Group 5 metal, Group 6 metal, Group 7 metal, Group 8 metal, Group 9 metal, Group 10 metal, Group 11 metal, Group 12 metal, and a combination thereof. In some embodiments, the metal chalcogenide comprises a chalcogen atom selected from the group consisting of S, Se, and Te. In some embodiments, the metal chalcogenide is ZrS₂, ZnS, or a combination thereof. In some embodiments, the porous metal salt polymer composite structure comprises a metal oxalate. In some embodiments, the metal oxalate is selected from the group consisting of iron oxalate, copper oxalate, zirconium oxalate, aluminum oxalate, magnesium oxalate, nickel oxalate, cobalt oxalate, cerium oxalate, manganese oxalate, chromium oxalate, including but not limited to zinc oxalate. In some embodiments, the porous metal salt polymer composite structure comprises a metal carbonate. In some embodiments, the metal carbonate is selected from the group consisting of iron carbonate, copper carbonate, zirconium carbonate, aluminum carbonate, magnesium carbonate, nickel carbonate, cobalt carbonate, cerium carbonate, manganese carbonate, chromium carbonate, including but not limited to zinc carbonate.

In some embodiments, the method comprises producing a structural configuration of a porous metal salt polymer composite structure, and then converting the porous metal salt polymer composite structure to a porous metal-organic framework (MOF) composite structure. In some embodiments, a composite article comprises a porous fibrillated polymer membrane that includes supported particles durably enmeshed within the porous fibrillated polymer membrane. In some embodiments, the structural configuration of the composite article comprises: a film, a laminate, a tube, a wound roll, a tape, a pellet, a column, a monolith, a module, a honeycomb-shape, or a combination thereof.

In some embodiments, the converting the porous metal chalcogenide polymer composite structure to a porous MOF composite structure comprises a vapor treatment process. In some embodiments, the converting the porous metal chalcogenide polymer composite structure to a porous MOF composite structure comprises a liquid treatment process. In some embodiments, the porous metal chalcogenide polymer composite structure comprises Polytetrafluoroethylene (PTFE). In some embodiments, the porous metal chalcogenide polymer composite structure comprises poly(ethylene-co-tetrafluoroethylene) (ETFE), ultra-high molecular weight polyethylene (UHMWPE), polyparaxylylene (PPX), polylactic acid and any combination or blend thereof. In some embodiments, the porous MOF composite structure comprises PTFE. In some embodiments, the porous MOF composite structure comprises at least a MOF or a mixture of MOFs selected from the group consisting of ZIF-7, ZIF-8, ZIF-9, ZIF-10, ZIF-12, ZIF-67, ZIF-68, ZIF-69, ZIF-70, ZIF-78, ZIF-79, ZIF-81, ZIF-82, ZIF-90, ZIF-8-90, ZIF-L, CALF-15, CALF-20, MOF-2, MOF-3, MOF-4, MOF-5, MOF-70, MOF-73, MOF-74, MOF-75, MOF-76, MOF-177, COF-1, COF-5, COF-8, COF-105, COF-108, MIL-101, MIL-53, MIL-53-NH2, MIL-96, CAU-10, CAU-10-H, MOF-303, MOF-505, MOF-801, MOF-808, Al(OH)fumarate, Mg-formate, Zr-Fumarate, UiO-66, UIO-66-NH2, UiO-67, UIO-68, HKUST-1, Fe-BTC, PCN-224, PCN-250, and UTSA-16.

In some embodiments, porosity of porous metal chalcogenide polymer composite includes a range of about 10% to about 95%.

In some embodiments, the porous metal chalcogenide polymer composite structure comprises a porous ZnO PTFE composite structure. In some embodiments, the porous MOF composite structure comprises ZIF-8-PTFE. In some embodiments, the porous metal chalcogenide polymer composite structure comprises a porous metal oxide polymer composite film. In some embodiments, the porous MOF composite structure comprises a porous MOF composite film. In some embodiments, the porous metal oxide polymer composite structure comprises a metal oxide polymer composite column. In some embodiments, the porous MOF composite structure comprises a porous MOF composite column.

In some embodiments, a porous MOF composite structure comprises PTFE; and MOF durably enmeshed in the PTFE. In some embodiments, a porous MOF composite structure comprises expanded polytetrafluoroethylene (ePTFE); and MOF durably enmeshed in the ePTFE. In some embodiments, a metal of the MOF is selected from the group consisting of transition metal, Group 4 metal, Group 5 metal, Group 6 metal, Group 7 metal, Group 8 metal, Group 9 metal, Group 10 metal, Group 11 metal, Group 12 metal, Group 13 metal, V, Fe, Cu, Zn, Al, Zr, Mg, Mn, Co, and Ni. In some embodiments, the porous MOF composite structure has a Brunauer-Emmett-Teller (BET) surface area which is in the range of 20-4000 m²/g. In some embodiments, the porous MOF composite structure comprises a porous MOF composite film. In some embodiments, the porous MOF composite film has a thickness of about 0.001 mm to 5 mm. In some embodiments, the porous MOF composite film has a thickness of about 0.001 mm to 0.01 mm. In some embodiments, the porous MOF composite film has a thickness of about 0.01 mm to 1.5 mm. In some embodiments, the porous MOF composite film has a thickness of about 0.01 mm to 5 mm. In some embodiments, the porous MOF composite film has a thickness of about 1.5 mm to 5 mm.

In some embodiments, the porous MOF composite film comprises a MOFs layer on at least one side of an external surface of the porous MOF composite film. In some embodiments, the porous MOF composite film comprises a MOFs layer on at least two sides of an external surface of the porous MOF composite film.

In some embodiments, the MOFs layer on the external surface has a thickness of about 0.001 mm to about 5 mm. In some embodiments, the MOFs layer on the external surface has a thickness of about 0.001 mm to about 0.01 mm. In some embodiments, the MOFs layer on the external surface has a thickness of about 0.01 mm to about 1.5 mm. In some embodiments, the MOFs layer on the external surface has a thickness of about 0.01 mm to about 5 mm. In some embodiments, the MOFs layer on the external surface has a thickness of about 1.5 mm to about 5 mm.

In some embodiments, the porous MOFs composite structure has a tensile strength greater than 1 pound per square inch.

Accordingly, the present invention provides a method of producing a structured MOF composite tape by immobilizing metal chalcogenide particles into a polymer matrix, and then converting the metal chalcogenide into MOF in-situ. In some embodiments, the conversion is from ZnO-PTFE composite to ZIF-8-PTFE composite. ZIF-8-PTFE composite is a useful material for propylene/propane separation, oil capture, and photocatalytic killing against airborne bacteria. Besides ZIF-8, a structured MOF composite tape is a useful material for chemical separation including but not limited to chemical purification, air purification, and removal of biological toxicants. Additionally, a composite article which includes the MOFs may be in the form of a filter bag, a honeycomb, a column, or other suitable forms.

### BRIEF DESCRIPTION OF THE DRAWINGS

References are made to the accompanying drawings, which form a part of this disclosure, and which illustrate examples of the systems and methods described herein. Like reference numbers represent like parts throughout.

FIG. 1 illustrates an exemplary and nonlimiting schematic flowchart for an exemplary method producing ZIF-8-PTFE composite from ZnO embedded onto PTFE.

FIG. 2 illustrates an example of a particle size distribution of ZnO obtained according to this nonlimiting exemplary process.

FIG. 3 illustrates an example of a pore size distribution and cumulative pore volume of ZnO-PTFE composite film according to a nonlimiting embodiment.

FIG. 4 illustrates an exemplary amount of ZnO-PTFE on the surface area before after the conversion process according to a nonlimiting embodiment.

FIG. 5 illustrates an example of a comparative graph according to a nonlimiting exemplary process.

FIG. 6 illustrates an example of a cross-sectional scanning electron microscope elemental mapping according to an embodiment.

FIG. 7 illustrates an example of a cross-sectional scanning electron microscope elemental mapping according to an embodiment.

FIG. 8 illustrates an example of a comparative graph according to a nonlimiting exemplary process.

FIG. 9 illustrates an example of a high-resolution scanning electron microscope image according to an embodiment.

FIG. 10 illustrates an example of a high-resolution scanning electron microscope image according to an embodiment.

FIG. 11 illustrates an example of a comparative chart of the CO₂ uptake measurements according to an embodiment.

### DETAILED DESCRIPTION

The cost of metal chalcogenide (e.g., metal oxide) can be several orders of magnitude lower than the cost of MOFs. Accordingly, the embodiments of the methods disclosed herein are able to produce economically feasible, large scale, high quality porous MOF composite structures. Further, the conversion of metal chalcogenide can be conducted in-situ. Accordingly, there is no need to directly obtain MOF powder or particles to embed the obtained MOF to a polymer membrane or film. That is, according to this exemplary process, the process of enmeshing MOF powder directly to a polymer membrane can be eliminated. Thus, some embodiments do not include providing or obtaining a MOF powder. Further, some embodiments do not include enmeshing MOF powder directly to a polymer membrane or film. Nonlimiting examples of the embodiments are provided in greater detail below.

In some embodiments of the methods disclosed herein are directed towards converting a porous metal salt polymer composite structure to a porous metal-organic framework (MOF) composite structure. In some embodiments, the porous metal salt polymer composite structure comprises a metal oxide.

In some embodiments, the metal oxide is durably enmeshed within a polymer membrane, and then the metal oxide is converted to a MOF while supported on the polymer membrane.

In some embodiments, the polymer membrane has at least one node and connecting fibril microstructure. The fibril microstructure includes fibrils that interconnect with other fibrils or nodes to form a net-like structure. Particles are disposed and immobilized within this net-like structure. In some embodiments, the fibrillated polymer membrane forms a network of fibrils immobilizing and enmeshing to support particles within the fibrillated microstructure. In some embodiments, the polymer membrane is or includes a PTFE membrane which has at least one node and connecting fibril microstructure. In some embodiments, the polymer membrane is or includes an ePTFE membrane which has at least one node and connecting fibril microstructure.

As used herein, the phrase “durably enmeshed” describes something that is non-covalently immobilized within the fibrillated microstructure of a polymer membrane. For example, “a catalyst particle that is durably enmeshed within a polymer membrane” describes a structural relationship of a catalyst particle that is non-covalently immobilized within the fibrillated microstructure of the polymer membrane. In some embodiments of a “durably enmeshed” catalyst particle, there is no separate binder which is present to fix the catalyst particles in the membrane. In some embodiments, the catalyst particle is disposed throughout the thickness of the fibrillated polymer membrane.

TABLE 1 shows various nonlimiting examples of MOF composite structures that can be produced via in-situ conversions of metal oxides. TABLE 1 also lists various organic linkers that can be used, as well as the solvent that can be used in the respective processes. For example, as shown in TABLE 1, ZnO can be converted to ZIF-8 using 2-methylimidazole as the organic linker without using a solvent.

TABLE 1

| | Metal | | |
|---|---|---|---|
| MOF | oxide | Organic linker | Solvent |
| ZIF-8 | ZnO | 2-methylimidazole | None |
| ZIF-8 | ZnO | 2-methylimidazole | Methanol |
| ZIF-L | ZnO | 2-methylimidazole | Water |
| MOF-5 | ZnO | 1,4-benzenedicarboxylic | N,N- |
| | | acid | dimethylformamide |
| | | | (DMF) |
| MOF-74 | ZnO | 2,5- | DMF |
| | | dihydroxyterephthalic | |
| | | acid | |
| MOF-177 | ZnO | 1,3,5- | DMF |
| | | benzenetribenzoate | |
| MIL-53 | Al₂O₃ | 1,4-benzenedicarboxylic | None |
| | | acid | |
| MIL-53 | Al₂O₃ | 1,4-benzenedicarboxylic | Water |
| | | acid | |
| MIL-53 | Al₂O₃ | 1,4-benzenedicarboxylic | Water and DMF |
| | | acid | |
| MIL-53-NH2 | Al₂O₃ | 2-aminoterephthalic acid | None |
| MIL-53-NH2 | Al₂O₃ | 2-aminoterephthalic acid | Water |
| MIL-96 | Al₂O₃ | trimesic acid | None |
| MIL-96 | Al₂O₃ | trimesic acid | Water |
| CAU-10 | Al₂O₃ | 1,3-benzenedicarboxylic | None |
| | | acid | |
| CAU-10 | Al₂O₃ | 1,3-benzenedicarboxylic | Water and DMF |
| | | acid | |
| MOF-303 | Al₂O₃ | 3,5-pyrazoledicarboxylic | Water |
| | | acid monohydrate | |
| MOF-801 | ZrO₂ | Fumaric acid | DMF |
| MOF-808 | ZrO₂ | 1,3,5- | DMF and formic |
| | | benzenetricarboxylic | acid |
| | | acid | |
| UiO-66 | ZrO₂ | 1,4-benzenedicarboxylic | DMF |
| | | acid | |
| UiO-66-NH2 | ZrO₂ | 2-aminobenzene-1,4- | DMF |
| | | dicarboxylic acid | |
| UiO-67 | ZrO₂ | Biphenyl-4,4′- | dimethyl sulfoxide |
| | | dicarboxylic acid | (DMSO) |
| HKUST | CuO | benzene-1,3,5- | Water |
| | | tricarboxylic acid | |
| MOF-74 | MgO | 4,4′-Dihydroxy-(1,1′- | DMF |
| | | biphenyl)-3,3′- | |
| | | dicarboxylic Acid | |
| MOF-74 | ZnO | 4,4′-Dihydroxy-(1,1′- | DMF |
| | | biphenyl)-3,3′- | |
| | | dicarboxylic Acid | |
| MOF-74 | MnO | 4,4′-Dihydroxy-(1,1′- | DMF |
| | | biphenyl)-3,3′- | |
| | | dicarboxylic Acid | |
| MOF-74 | CoO | 4,4′-Dihydroxy-(1,1′- | DMF |
| | | biphenyl)-3,3′- | |
| | | dicarboxylic Acid | |
| MOF-74 | NiO | 4,4′-Dihydroxy-(1,1′- | DMF |
| | | biphenyl)-3,3′- | |
| | | dicarboxylic Acid | |

### Example 1: Conversion of ZnO to ZIF-8 on PTFE

The following nonlimiting exemplary process is able to produce economically feasible, large scale, high quality ZnO-PTFE composites. Further, the conversion of ZnO to ZIF-8 can be conducted on the ZnO-PTFE composite. Accordingly, there is no need to directly obtain ZIF-8 powder or embedding ZIF-8 particles to PTFE. That is, according to this exemplary process, the process of enmeshing ZIF-8 powder directly to PTFE can be eliminated. Thus, in some embodiments, the methods do not include obtaining ZIF-8 powder. Further, in some embodiments, the methods do not include enmeshing ZIF-8 powder directly to PTFE.

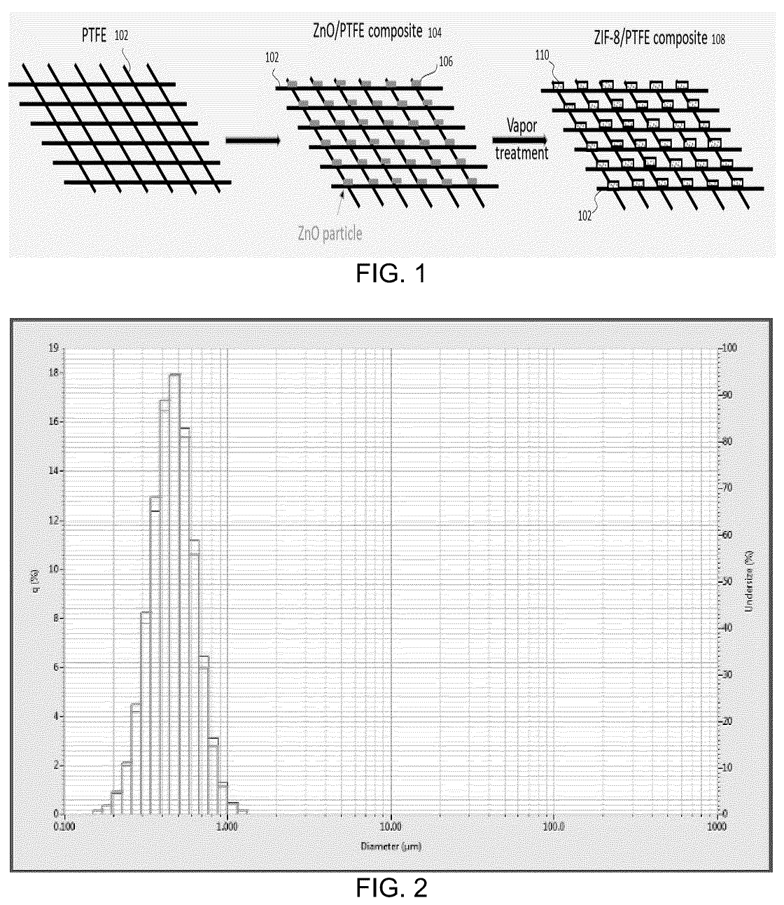

FIG. 1 shows an embodiment of a method of forming an embodiment of a composite material. The embodiment includes mixing a PTFE 102 and a metal oxide to form, for example, a metal oxide PTFE composite. FIG. 1 shows an embodiment in which the PTFE is made first, in isolation from particles of metal oxides. Alternatively, the PTFE 102 is not first made in isolation from particles of metal oxides; that is, in an alternative embodiment, during the forming of PTFE 102, metal oxides are mixed in to durably enmesh the metal oxide to the PTFE 102. For example, to form a ZnO-PTFE composite 104, the PTFE 102 is formed together with particles of ZnO 106, during which the ZnO 106 is durably enmeshed within or onto the PTFE 102. Then, ZIF-8-PTFE composite 108 can be produced by, for example, a vapor treatment process, which converts some or all of the ZnO 106 to ZIF-8 110 while the ZnO 106 is durably enmeshed on the PTFE 102. The resulting composite material can have a mixture of ZnO and ZIF-8 durably enmeshed on the PTFE. Thus, in some embodiments, the PTFE 102 is not first made in isolation from particles of metal oxides.

In some embodiments, the conversion process can control the amount of the ZnO 106 to ZIF-8 110 conversion with respect to their location on the PTFE 102. For example, the conversion of ZnO 106 to ZIF-8 110 can be performed on the external thin layer of the ZnO-PTFE composite 108 by controlling the porosity of the ZnO-PTFE composite 108, e.g., by reducing the porosity. For example, the conversion of ZnO 102 to ZIF-8 110 can be performed on the majority of the ZnO 106 of the ZnO-PTFE composite 108 by increasing the porosity of the ZnO-PTFE composite 108.

An example of the conversion process can be described as an “in-situ conversion,” whereby the porous polymer film composite of metal oxide particles is converted to a structured porous film composite of porous MOF particles in liquid phase. In some embodiments, the conversion process is performed at low temperature ranges.

FIG. 2 shows the particle size distribution of ZnO obtained according to this nonlimiting exemplary process. As can be seen from FIG. 2, the average particle size (i.e., particle diameter) of ZnO in this example was around 0.5-0.6 μm, as measured by Horiba LA-350 laser scattering particle size distribution analyzer. A composite blend of 50 wt % ZnO particles and 50 wt % PTFE was blended in a manner generally taught in United States Publication No. 2005/0057888 to Mitchell, et al. The resulting porous fibrillated ePTFE composite films included about 50% ZnO particles by weight durably enmeshed and immobilized with the ePTFE node and fibril matrix.

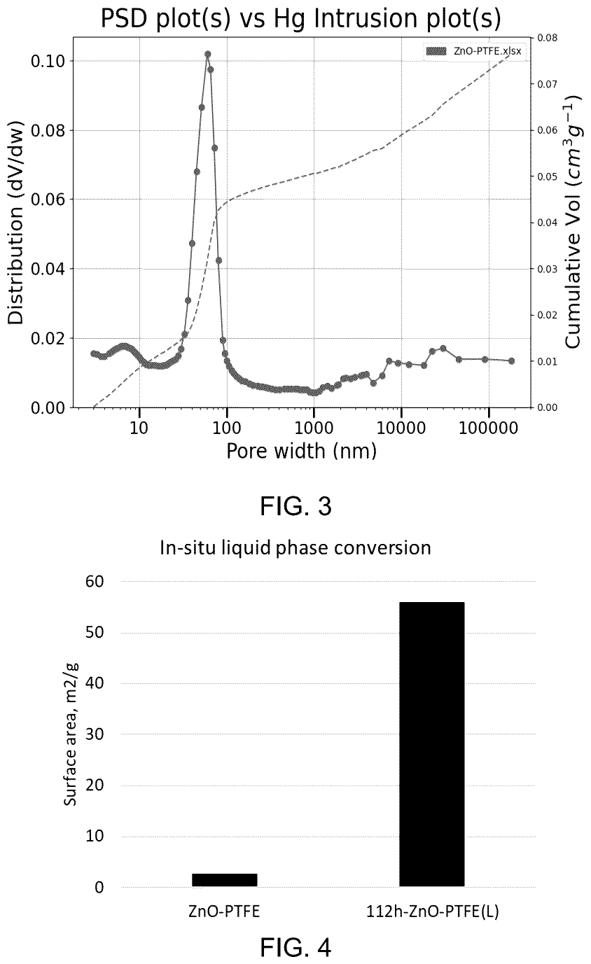

FIG. 3 shows the pore size distribution and cumulative pore volume of ZnO-PTFE composite film. The pore size distribution and cumulative pore volume of the ZnO-PTFE composite film obtained was measured by a Micromeritics AutoPore V mercury porosimeter (Micromeritics, Norcross, Ga., USA).

In some embodiments, the ZnO-PTFE composite film in this example had a major pore size of around 60 nm. In some embodiments, the porosity of ZnO-PTFE composite film was measured in the range of 26-29%.

In some embodiments, the high porosity ZnO-PTFE composite film showed additional pores greater than 0.1 μm. In some embodiments, the porosity of high porosity ZnO-PTFE composite film was measured in the range of 59-71%. The porosity is calculated by 100*(1-bulk density/skeletal density). Bulk density was obtained on a Micrometitics AutoPore V mercury porosimeter (Micromeritics, Norcross, Ga., USA). The skeletal density is obtained on a helium pycnometer (UltraPyc 1200e, Quantachrome instruments).

The conversion process was then performed on the ZnO-PTFE composite film. The process in this example was an in-situ liquid phase conversion at low temperature process. In this example, a 10 mm diameter sample was die cut from a 0.55 mm thick, porous ZnO-PTFE film. The sample was placed in a 20 ml glass vial with 10 ml methanol and 0.4 g of 2-methylimidazole at 20° C. for 112 hours to convert the porous ZnO-PTFE film to porous ZIF-8-PTFE film. The specific surface area of the film sample was measured before and after the in-situ conversion by nitrogen physisorption at 77K (Nova, Quantachrome instruments) and calculated using the Brunauer-Emmett-Teller method. The specific surface area increased from 2.6 for ZnO-PTFE film to 56 m²/g for the 112 hours treated ZnO-PTFE film. FIG. 4 shows a comparative chart of the amount of ZnO-PTFE on the surface before the conversion process and the amount of the ZnO-PTFE (label: 112h-ZnO-PTFE(L)) on the surface after this in-situ conversion process.

### Example 2: Comparison of Low and High Porosity Composite

By controlling the conversion process, the resulting amount and location of the MOFs in the polymer membrane can be controlled. For example, MOFs can be formed substantially at the surface of the polymer membrane (i.e., not entirely throughout the polymer membrane), or MOFs can be formed throughout the polymer membrane, or any amount therebetween. Accordingly, one can tailor the conversion of to only surface or through tape/film.

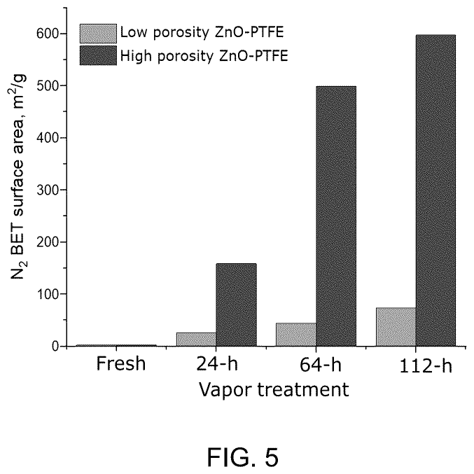

For example, FIG. 5 shows a comparative graph according to the following nonlimiting exemplary processes. Two 50% loading ZnO-PTFE composites were exposed to 2-methylimidazole vapor at 125° C. in a 50 ml autoclave. After 64 hours treatment, the conversion of ZnO-PTFE to ZIF-PTFE composite increased from 4 m²/g to 44.1 m²/g for the low porosity (26-29%) ZnO-PTFE composite. The conversion of ZnO-PTFE to ZIF-PTFE increased to 498.8 m²/g for the high porosity (59-71%) ZnO-PTFE composite.

By further increasing the treatment time to 112 hours, the conversion increased to 73.1 m²/g for the low porosity ZnO-PTFE composite. At 112 hours, the wt % of ZIF-8 produced by this conversion process was calculated to be about 4.2 wt %.

After treatment time of 112 hours, the conversion increased to 597.2 m²/g for the high porosity ZnO-PTFE composite. At 112 hours, the wt % of ZIF-8 produced by this conversion process was calculated to be about 34.1 wt %. The wt % of ZIF-8 in the composite is calculated using the surface area of composite divided by the surface area of ZIF-8 powder. The surface area of ZIF-8 powder is 1753 m²/g, measured by nitrogen physisorption at 77K (Nova, Quantachrome instruments).

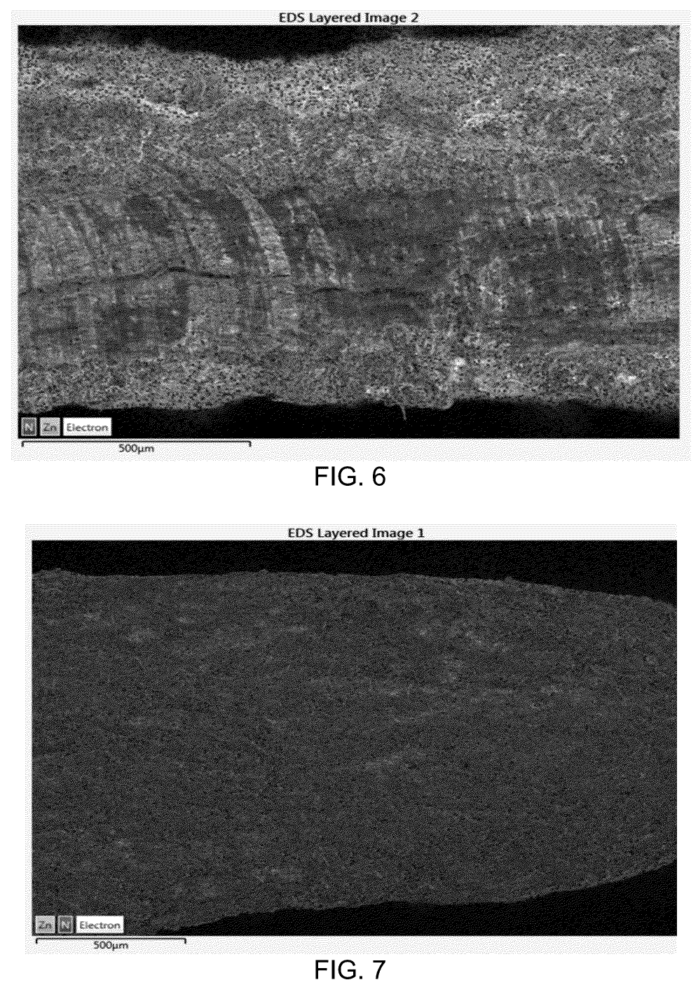

FIGS. 6 and 7 are cross-sectional scanning electron microscope (SEM) elemental mappings, where the detection of nitrogen evidences conversion of ZnO to ZIF-8. The cross-sectional energy dispersive spectroscopy elemental mapping was performed on Hitachi TM3030Plus microscope. The nitrogen signal on the external surface of the ZnO-PTFE composite film providing evidence that ZIF-8 was converted from ZnO in the ZnO-PTFE composite film. The specific surface area of the film sample was measured before and after the in-situ conversion by nitrogen physisorption at 77K (Nova, Quantachrome instruments) and calculated using the Brunauer-Emmett-Teller method.

The distribution of nitrogen (N) shown in FIG. 6 indicates that the conversion from ZnO to ZIF-8 mainly occurred on the external surface of the low porosity ZnO-PTFE composite. The thickness of the low porosity ZnO-PTFE tape was around 0.9-1.1 mm, while the thickness of MOFs (ZIF-8) layer on the external surface of ZnO-PTFE tape was around 0.1-0.4 mm.

The uniform distribution of N shown in FIG. 7 indicates that the conversion from ZnO to ZIF-8 was uniform through the whole composite. The thickness of the high porosity ZnO-PTFE tape was around 1.0-1.4 mm, while the thickness of MOFs (ZIF-8) layer was around 1.0-1.4 mm.

The successful conversion from ZnO to ZIF-8 was also confirmed by the x-ray diffraction and Fourier Transformed Infrared Spectroscopy (FTIR). In some embodiments, the conversion of ZnO to ZIF-8 can also be achieved by treating the ZnO-PTFE composite in 2-methylimidazole methanol solution at room temperature.

### Example 3: Conversion of Al₂O₃ to MIL-53 on PTFE

The following nonlimiting exemplary process is able to produce economically feasible, large scale, high quality MIL-53-PTFE composites. Further, the conversion of Al₂O₃ to MIL-53 can be conducted on the Al₂O₃-PTFE composite. Thus, in some embodiments, the methods do not include obtaining MIL-53 powder. Further, in some embodiments, the methods do not include enmeshing MIL-53 powder directly to PTFE.

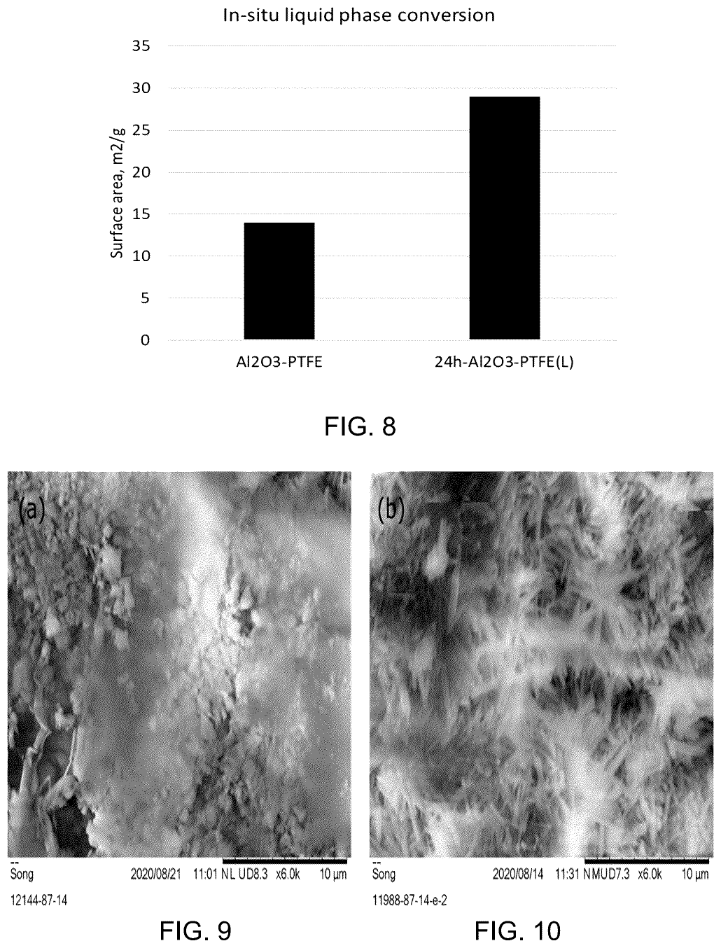

In this example, the in-situ conversion of porous polymer film composite of metal oxide particles to structured porous film composite of porous MOF particles is performed in liquid phase at high temperature. A composite blend of 50 wt % Aluminum oxide and 50 wt % PTFE was blended in a manner generally taught in United States Publication No. 2005/0057888 to Mitchell, et al. The resulting porous fibrillated expanded PTFE (ePTFE) composite films included 50 wt % Al₂O₃ particles that are durably enmeshed and immobilized within the ePTFE node and fibril matrix. Then, a 10 mm diameter sample was die cut from a 1.34 mm thick, porous Al₂O₃-PTFE film. The sample was placed in a 50 ml autoclave reactor with 10 ml DI water and 0.45 g of 1,4-benzenedicarboxylic acid at 220° C. for 24 hours to convert the porous Al₂O₃-PTFE film to porous MIL-53-PTFE film. The specific surface area of the film sample was measured before and after the in-situ conversion by nitrogen physisorption at 77K (Nova, Quantachrome instruments) and calculated using the Brunauer-Emmett-Teller method. FIG. 8 shows the comparative results. The specific surface area increased from 14 for Al₂O₃-PTFE film to 29 m²/g for the 24 hours treated Al₂O₃-PTFE film (label: 24h-Al₂O₃-PTFE (L)). FIG. 9 shows a high-resolution scanning electron microscope image of the Al₂O₃-PTFE film before the conversion. FIG. 10 shows a high-resolution scanning electron microscope image of the Al₂O₃-PTFE film after in-situ liquid phase conversion. The images in FIGS. 9 and 10 were obtained by using Hitachi TM3030Plus microscope. FIG. 9 shows cubic-like Al₂O₃ crystals in the Al₂O₃-PTFE film, whereas FIG. 10 shows needle-like MIL-53 crystals.

### Example 4: Conversion of Zinc Oxalate to CALF-20 on PTFE

Generally, zinc oxalate and 1,2,4-triazole are required to form CALF-20. Generally, this reaction requires 40% water, 60% methanol, and a temperature of 180° C. for 2 days.

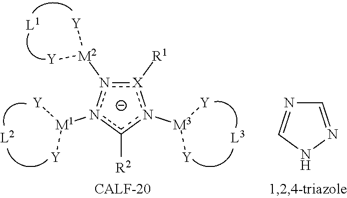

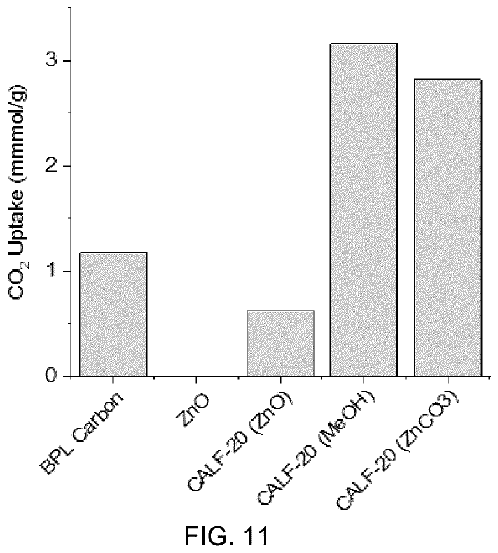

The following nonlimiting exemplary process includes an in-situ synthesis of CALF-20 from zinc oxalate durably embedded on PTFE. According to this process, zinc oxalate is mixed with PTFE to form a porous fibrillated structure. The reaction is carried out using 100% MeOH, which wets the PTFE. From the zinc oxalate-PTFE composite structure, the synthesis process (e.g., conversion) of the zinc oxalate to CALF-20 is performed in-situ. This results in the CALF-20-PTFE composite structure. The CO₂ uptake result is shown in FIG. 11.

### Example 5: Conversion of Zinc Carbonate to CALF-20 on PTFE

The following nonlimiting exemplary process is an “indirect” process for producing the CALF-20-PTFE composite structure. Unlike the exemplary process in Example 4 which requires obtaining zinc oxalate, this process includes obtaining zinc carbonate and oxalic acid (instead of zinc oxalate). This process can be about 20 times less expensive than using zinc oxalate for the production of CALF-20. According to this process, the basic zinc carbonate is reacted with oxalic acid at 25° C. to form zinc oxalate. Then, the zinc oxalate that is produced is durably enmeshed to PTFE, then the conversion of the zinc oxalate on the PTFE to CALF-20 is performed.

It has been determined that the CALF-20 produced via the “indirect” method (i.e., using ZnCO₃) has a slightly lower CO₂ uptake property than the CALF-20 produced via the “direct” method (i.e., using MeOH). However, it has been determined that the CALF-20 produced via both, the “direct” and “indirect” methods, have higher CO₂ uptake properties than BPL activated carbon. FIG. 11 shows a comparative chart of the CO₂ uptake measurements. Table 2 shows additional tests of the “indirect” conversion from zinc carbonate to CALF-20. For 50% ZnCO₃-PTFE tapes, as the percentage of pores greater than 0.1 μm over the total cumulative pore volume increased from 9.6% to 51.3%, the conversion to CALF-20 increased from 39% to 100%.

TABLE 2
Porosity and Conversion of Zinc Carbonate in PTFE Composite

| | Porosity | Total Intrusion | Conversion to |
|---|---|---|---|
| Zinc Carbonate | (>0.1 μm) | Volume | CALF-20 |
| Content (%) | (%)¹ | (mL/g)¹ | (%)² |
| 85 | 25.6 | 0.37 | 38 |
| 50 | 9.6 | 0.20 | 39 |
| 50 | 51.3 | 0.53 | 100 |
| 60 | 44.7 | 0.48 | 51 |
| 70 | 25.7 | 0.37 | 47 |

¹Based on mercury porosimetry
²Based on CO₂ uptake data using Thermalgravimetric Analysis (TGA)

The terminology used herein is intended to describe embodiments and is not intended to be limiting. The terms “a,” “an,” and “the” include the plural forms as well, unless clearly indicated otherwise. The terms “comprises” and “comprising,” when used in this disclosure, specify the presence of the stated features, integers, steps, operations, elements, components, or a combination thereof, but do not preclude the presence or addition of one or more other features, integers, steps, operations, elements, or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A method, comprising:
converting a porous metal salt polymer composite structure to a porous metal-organic framework (MOF) composite structure.

2. The method of claim 1, wherein the porous metal salt polymer composite structure comprises a metal chalcogenide polymer composite structure.

3. The method of claim 2, wherein the porous metal chalcogenide polymer composite structure comprises a metal oxide.

4. The method of claim 3, wherein the metal oxide is selected from the group consisting of transition metal oxide, Group 4 metal oxide, Group 5 metal oxide, Group 6 metal oxide, Group 7 metal oxide, Group 8 metal oxide, Group 9 metal oxide, Group 10 metal oxide, Group 11 metal oxide, Group 12 metal oxide, Group 13 metal oxide, and a combination thereof.

5. The method of claim 3, wherein the metal oxide is selected from the group consisting of V₂O₅, Fe₂O₃, CuO, ZnO, Al₂O₃, ZrO₂, MgO, MnO, CoO, NiO, and a combination thereof.

6. The method of claim 2, wherein the porous metal chalcogenide polymer composite structure comprises a metal chalcogenide.

7. The method of claim 6, wherein the metal chalcogenide comprises at least one metal atom, wherein the at least one metal atom is selected from the group consisting of a transition metal, Group 3 metal, Group 4 metal, Group 5 metal, Group 6 metal, Group 7 metal, Group 8 metal, Group 9 metal, Group 10 metal, Group 11 metal, Group 12 metal, and a combination thereof.

8. The method of claim 7, wherein the metal chalcogenide comprises a chalcogen atom selected from the group consisting of S, Se, and Te.

9. The method of claim 6, wherein the metal chalcogenide is ZrS₂, ZnS, or a combination thereof.

10. The method of claim 1, wherein the porous metal salt polymer composite structure comprises a metal oxalate.

11. The method of claim 10, wherein the metal oxalate is selected from the group consisting of iron oxalate, copper oxalate, zirconium oxalate, aluminum oxalate, magnesium oxalate, nickel oxalate, cobalt oxalate, cerium oxalate, manganese oxalate, chromium oxalate, including but not limited to zinc oxalate.

12. The method of claim 1, wherein the porous metal salt polymer composite structure comprises a metal carbonate.

13. The method of claim 12, wherein the metal carbonate is selected from the group consisting of iron carbonate, copper carbonate, zirconium carbonate, aluminum carbonate, magnesium carbonate, nickel carbonate, cobalt carbonate, cerium carbonate, manganese carbonate, chromium carbonate, including but not limited to zinc carbonate.

14. The method of claim 1, further comprising:
producing a structural configuration of the porous metal salt polymer composite structure.

15. The method of claim 14, wherein the structural configuration comprises:
a film, a laminate, a tube, a wound roll, a tape, a pellet, a column, a monolith, a module, a honeycomb-shape, or a combination thereof.

16. The method of claim 1, wherein the converting the porous metal salt polymer composite structure to a porous MOF composite structure comprises a vapor treatment process.

17. The method of claim 1, wherein the converting the porous metal salt polymer composite structure to a porous MOF composite structure comprises a liquid treatment process.

18. The method of claim 1, wherein the porous metal salt polymer composite structure comprises Polytetrafluoroethylene (PTFE).

19. The method of claim 1, wherein the porous metal salt polymer composite structure comprises poly(ethylene-co-tetrafluoroethylene) (ETFE), ultra-high molecular weight polyethylene (UHMWPE), polyparaxylylene (PPX), polylactic acid and any combination or blend thereof.

20. The method of claim 1, wherein the porous MOF composite structure comprises PTFE.

21. The method of claim 1, wherein the porous MOF composite structure comprises at least a MOF or a mixture of MOFs selected from the group consisting of ZIF-7, ZIF-8, ZIF-9, ZIF-10, ZIF-12, ZIF-67, ZIF-68, ZIF-69, ZIF-70, ZIF-78, ZIF-79, ZIF-81, ZIF-82, ZIF-90, ZIF-8-90, ZIF-L, CALF-15, CALF-20, MOF-2, MOF-3, MOF-4, MOF-5, MOF-70, MOF-73, MOF-74, MOF-75, MOF-76, MOF-177, COF-1, COF-5, COF-8, COF-105, COF-108, MIL-101, MIL-53, MIL-53-NH2, MIL-96, CAU-10, CAU-10-H, MOF-303, MOF-505, MOF-801, MOF-808, Al(OH)fumarate, Mg-formate, Zr-Fumarate, UiO-66, UiO-66-NH2, UiO-67, UiO-68, HKUST-1, Fe-BTC, PCN-224, PCN-250, and UTSA-16.

22. The method of claim 2, wherein porosity of porous metal chalcogenide polymer composite includes a range of about 10% to about 95%.

23. The method of claim 22, wherein at least 5% of porosity comprises a pore size greater than 0.1 μm.

24. The method of claim 1, wherein the porous metal salt polymer composite structure comprises a porous ZnO PTFE composite structure.

25.-29. (canceled)

30. The method of claim 1, further comprising:
forming the porous metal salt polymer composite structure.

31-41. (canceled)
